(19) United States
(12) Patent Application Publication
(10) Pub. No.: US 2016/0049056 A1
(43) Pub. Date: Feb. 18, 2016

(54) NEAR FIELD COMMUNICATION SECURITY DEVICES

(71) Applicant: INVUE SECURITY PRODUCTS INC., Charlotte, NC (US)

(72) Inventors: Jeffrey A. Grant, Charlotte, NC (US); Gary A. Taylor, Fort Mill, SC (US)

(21) Appl. No.: 14/779,470

(22) PCT Filed: Apr. 9, 2014
(86) PCT No.: PCT/US14/33484

§ 371 Date: Sep. 23, 2015

Related U.S. Application Data
(60) Provisional application No. 61/811,354, filed on Apr. 12, 2013.
(60) Provisional application No. 61/815,895, filed on Apr. 25, 2013.
(60) Provisional application No. 61/871,362, filed on Aug. 29, 2013.

(51) Int. Cl. G08B 13/24; H04B 5/00

(52) U.S. Cl. CPC G08B 13/2405; H04B 5/0056

(57) ABSTRACT

Embodiments of the present invention are directed to security devices, articles of merchandise, and methods for securing an article of merchandise. For example, a security device includes at least one near field communication (NFC) tag coupled to the article of merchandise, wherein the NFC tag is configured to detect at least one security event in response to tampering with the article of merchandise.

### CROSS REFERENCE TO RELATED APPLICATIONS

The present application claims priority to U.S. Provisional Application No. 61/811,354, filed Apr. 12, 2013, U.S. Provisional Application No. 61/815,895, filed Apr. 25, 2013, and U.S. Provisional Application No. 61/871,362, filed Aug. 29, 2013, the contents of which are each incorporated by reference herein in its entirety.

### FIELD OF THE INVENTION

Embodiments of the present invention relate generally to devices for securing articles utilizing near field communication.

### BACKGROUND OF THE INVENTION

Retailers routinely display articles of merchandise, such as mobile phones, portable computers (e.g. notebooks, laptops, tablets, etc.), e-readers, media players, and the like for customers to evaluate before making a purchase. These articles of merchandise are continually being made smaller and lighter in weight due to advances in technology and materials. As a result, such merchandise is increasingly vulnerable and susceptible to theft. At the same time, the retail price and profit margin for such merchandise continues to decline. Accordingly, these articles of merchandise need to be secured by a security device that effectively and cost efficiently protects the merchandise from theft.

### BRIEF SUMMARY

Embodiments of the present invention are directed to security devices for securing an article of merchandise. In one embodiment, a security device includes at least one near field communication (NFC) tag coupled to the article of merchandise, wherein the at least one NFC tag is configured to detect at least one security event in response to tampering with the article of merchandise. The at least one NFC tag may be configured to communicate with the article of merchandise to generate a security signal in response to detecting a security event.

In some embodiments, the at least one NFC tag is contained within the article of merchandise. The at least one NFC tag may be configured to be in engagement with a battery cover of the article of merchandise when the battery cover is secured to the article of merchandise. The security event may be indicative of the battery cover being removed from the article of merchandise. In one aspect, the security device also includes an actuation member configured to interact with the at least one NFC tag when the battery cover is secured to or removed from the article of merchandise. The at least one NFC tag may be configured to detect removal of the battery cover of the article of merchandise in response to actuation of the actuation member. The actuation member may include a shorting member secured to the battery cover of the article of merchandise and opposite the at least one NFC tag so as to be configured to short the at least one NFC tag when the battery cover is secured to the article of merchandise. In another aspect, the actuation member is coupled to the at least one NFC tag and is configured to be actuated in response to engagement and disengagement with the battery cover of the article of merchandise. In one embodiment, the security device may also include a sensor comprising at least one NFC tag configured to be coupled to the article of merchandise, wherein the at least one NFC tag of the sensor is configured to detect at least one security event in response to tampering of the sensor.

In another embodiment, a hand-held article of merchandise is provided. The article of merchandise includes a housing, a processor disposed within the housing, a battery cover removably secured to the housing, and at least one near field communication (NFC) tag contained within the housing and in communication with the processor. The article of merchandise also includes a battery disposed within the housing for powering the processor and the at least one NFC tag, wherein the NFC tag is configured to detect removal of the battery cover from the housing. In some aspects, the article of merchandise also includes an actuation member disposed within the housing and configured to interact with the at least one NFC tag when the battery cover is secured to or removed from the article of merchandise. The actuation member may include a shorting member coupled to the battery cover configured to short the at least one NFC tag when the battery cover is removably secured to the housing. The actuation member may be coupled to the at least one NFC tag and may be configured to be actuated in response to engagement and disengagement with the battery cover of the article of merchandise.

In another embodiment, a method for securing an article of merchandise is provided. The method includes detecting at least one security event with at least one NFC tag associated with the article of merchandise in response to tampering with the article of merchandise. The method also includes generating a security signal in response to detecting the at least one security event. In some instances, the at least one NFC tag is coupled to the article of merchandise. The at least one NFC tag may be positioned within the article of merchandise. In addition or alternatively, the at least one NFC tag may be contained within a sensor configured to be coupled to the article of merchandise. The at least one NFC tag may be coupled to the article of merchandise such that the at least one NFC tag is configured to be in engagement with a battery cover of the article of merchandise when the battery cover is secured to the article of merchandise. In one aspect, the detecting step includes detecting that a battery cover of the article of merchandise has been removed.

According to another embodiment, a security system for securing an article of merchandise is provided. The security system includes a security device comprising at least one near field communication (NFC) tag coupled to the article of merchandise, wherein the NFC tag is configured to detect at least one security event in response to tampering with the article of merchandise. The security system also includes a key comprising at least one NFC tag configured to communicate with the at least one NFC tag of the security device to arm or disarm the security device. In one aspect, the key comprises a pair of NFC tags, wherein a first of the pair of NFC tags is configured to communicate with the security device for a predetermined period of time, and a second of the pair of NFC tags is configured to communicate with the security device after the predetermined period of time.

### BRIEF DESCRIPTION OF THE DRAWINGS

FIG. 1 is a schematic illustration of an article of merchandise according to one embodiment of the present invention.

FIG. 2 is a schematic illustration of a security device including a plurality of NFC tags according to one embodiment of the present invention.

FIG. 3 is a schematic illustration of a security device including a plurality of NFC tags according to another embodiment of the present invention.

FIG. 4 is a schematic illustration of a security device including a plurality of NFC tags according to one embodiment of the present invention.

FIG. 5 is a schematic illustration of a security device including a plurality of NFC tags according to an embodiment of the present invention.

FIG. 6 is a schematic illustration of a key according to one embodiment of the present invention.

### DETAILED DESCRIPTION OF EMBODIMENTS OF THE INVENTION

Embodiments of the present invention will now be described more fully hereinafter with reference to the accompanying drawings, in which various embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

One or more exemplary embodiments of a device for securing an article are described below. The article of merchandise M is typically a display model or an operational sample of electronic merchandise, such as portable computers (e.g. notebooks, laptops, tablets, etc.), hand-held electronic devices (e.g., mobile phones or smart phones), e-readers, cameras, media players, and the like, for a customer to examine before making a decision to purchase the item. The article of merchandise M is typically displayed in a manner that permits a prospective purchaser to evaluate the operation and features of the merchandise, while protecting the merchandise from a potential thief. It is understood that although the term “article of merchandise” is used herein, various articles, objects, and devices may be secured in a variety of environments, such as in retail, school, hospital, and restaurant environments, where such articles may be used and there is a desire to secure such articles. As explained in further detail below, the article of merchandise may be any article, object, or device capable of near field communication (NFC).

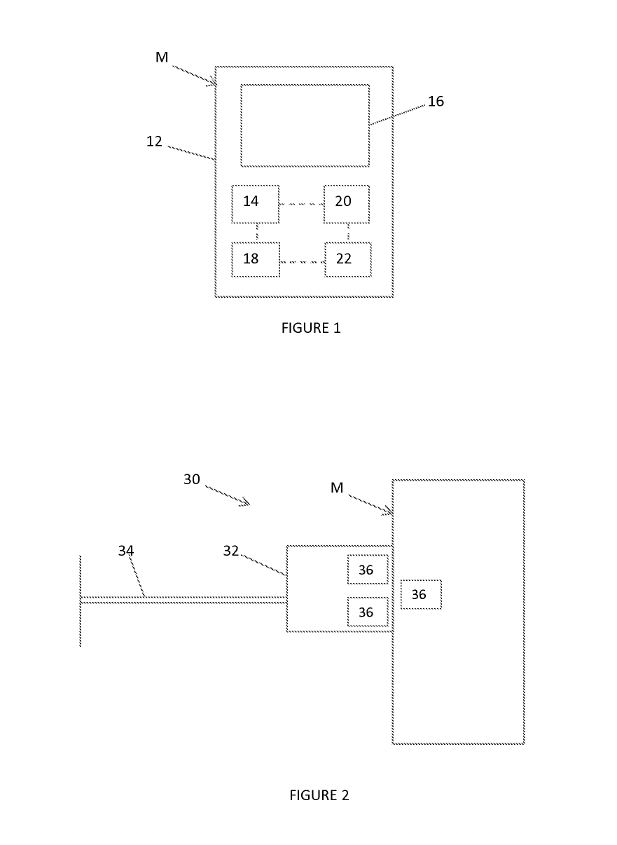

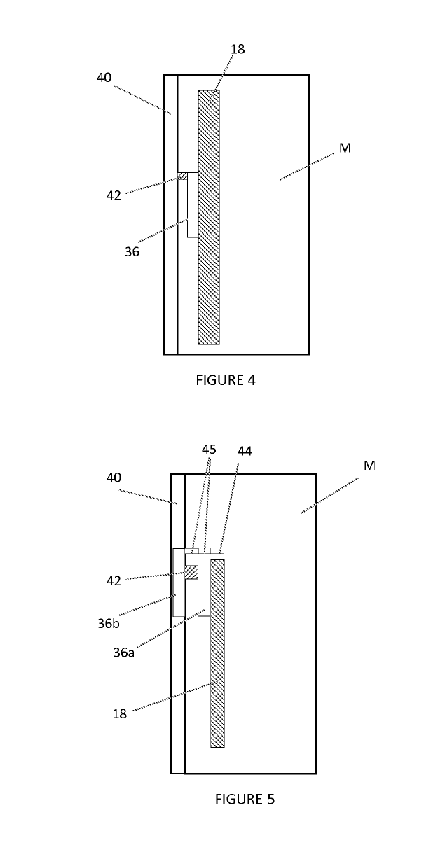

In one embodiment, the article of merchandise M is a hand-held device, such as a smart phone. As shown in FIG. 1, the article of merchandise M may include various components, such as, for example, a housing 12, a processor 14 disposed within the housing, a display 16 coupled to the housing, a battery 18 for powering the device, wireless communication functionality 20, memory, SIM card, SM card, and a battery cover removably secured to the housing (see, e.g., FIGS. 4 and 5). The article of merchandise M may also include various functionality for generating a security signal, such as alarm means 22 for generating an audible alarm (e.g., a piezoelectric alarm), display means for providing a visible message on the display 16, means for generating a haptic signal (e.g., vibration), and/or means for terminating the article's functionality (e.g., requiring a code for shutting the power off and rendering input devices inoperable).

Security has usually been provided to electronic articles of merchandise M by means of security devices that utilize a pressure switch to detect the device on display. When the article of merchandise M is removed, an alarm sounds. These security devices have been problematic in the market for several reasons. First, a sensor including a pressure switch is prone to false alarms if the article of merchandise M is not mounted correctly, or as the adhesive attaching the article of merchandise M starts to wear. Secondly, pressure switches are defeatable by thieves by sliding a thin piece of material such as a razor blade over the switch, allowing the thief to remove the article of merchandise M without triggering an alarm. Or, the thief may simply remove the battery cover attached to the sensor and the battery, thereby defeating the alarm. Utilizing improved security techniques to detect theft or attempted theft of the article of merchandise M would be an improvement over current technology.

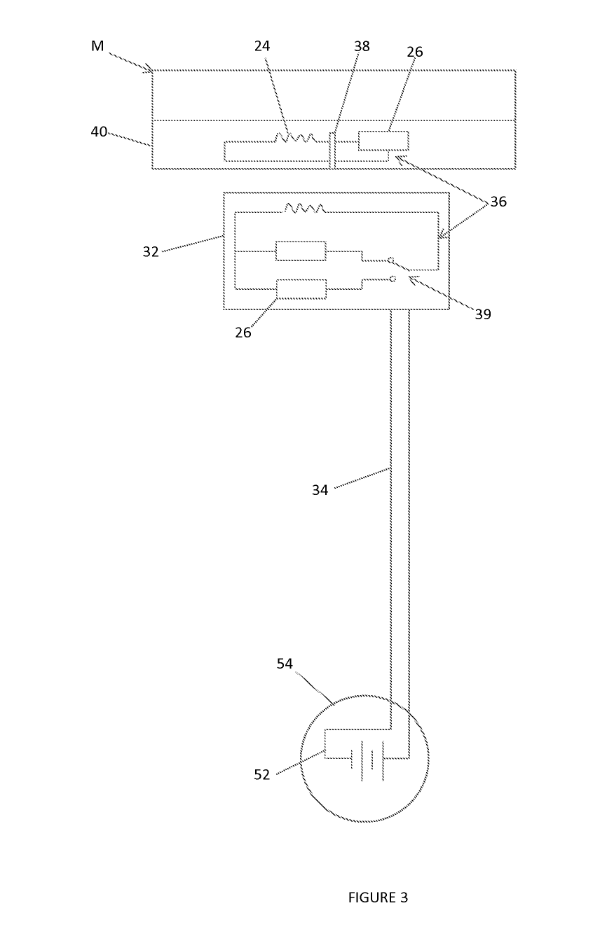

It is well known in the industry that electronic products such as smart phones may include NFC functionality. In this regard, devices may communicate with one another via NFC to transmit data when the devices are positioned near one another or in direct contact with one another. An NFC tag may include various components, such as an antenna or a coil 24 and one or more chips 26 that define an electrical circuit (see, e.g., FIGS. 3 and 4). The antenna 24 may be used for effectuating communication with an article of merchandise M or another NFC tag, which may be activated via a magnetic field. For example, a magnetic field may be generated by an article of merchandise M to communicate with an NFC tag. NFC functionality may be integrated into the device or added on, such as via a SIM card or microSD card having an NFC tag. NFC may be used for a variety of purposes, such as in commerce, social networking, and performing tasks. The wireless functionality of NFC would be useful for securing articles, such as in a retail environment. Accordingly, there exists a need for improved techniques for securing articles with NFC technology.

In one embodiment shown in FIG. 2, a security device 30 includes a sensor 32 coupled to an article of merchandise M, and a tether 34 or cable secured to the sensor. According to embodiments of the present invention, the security device 30 includes one or more NFC tags 36 for detecting one or more security events, such as tampering with the article of merchandise M, sensor 32, and/or tether 34 or recoiler cable. For example, the NFC tag(s) 36 may be configured to detect the removal of a battery cover 40, the removal of a security sensor 32 from the article of merchandise, the cutting of a tether 34 or cable, and/or a signal from an arming/disarming key 50. The article of merchandise M may include a software application that functions in cooperation with the NFC tag 36 to facilitate the detection of such security events and to generate a security signal. For example, the application may provide for a particular security signal(s) to be generated in the event that the NFC tag 36 detects certain conditions or security events and communicates the same to the article of merchandise M. The NFC tags 36 may be active or passive, as known to those skilled in the art. The security device 30 may be used to display or otherwise secure the article of merchandise M. For instance, the security device 30 may include a base, puck, stand, or the like for receiving and removably supporting the article of merchandise M. Alternatively, the article of merchandise M may be placed directly on a display surface.

The security device 30 may include one or more NFC tags 36 in a variety of locations. In this regard, one or more NFC tags 36 may be coupled to and disposed within the article of merchandise M. For example, the NFC tag 36 and an actuation member 38, such as a shorting member, may be secured within the article of merchandise M (e.g., with pressure-sensitive adhesives) for interacting with the NFC tag (see e.g., FIG. 3). In other embodiments, the NFC tag 36 and shorting member 38 may be integrated with the article of merchandise M, such as by molding the shorting member within the battery cover 40. By placing an NFC tag 36 inside the article of merchandise M, such as a mobile device, and adding a shorting member 38 on the battery cover 40 that shorts out the NFC circuit when the cover is placed onto the article, the article will not be able to read or otherwise communicate with the NFC tag. For example, the shorting member 38 may be a metal material that is adhered or otherwise secured to the battery cover 40, while the NFC tag 36 is secured opposite the shorting member inside the article of merchandise, such as on the battery 18. When the cover 40 is removed, the shorting member 38 will be removed from the NFC tag 36 thereby allowing the article of merchandise M to read the NFC tag and determine that the battery cover has been removed. In this instance, the article of merchandise M may be configured to generate a security signal, such as an audible and/or a visible alarm, in response to the security event.

Other techniques may be employed to detect various security events associated with the article of merchandise M, such as the removal of the battery cover 40 or other removable feature on the article of merchandise. For instance, FIG. 4 illustrates that an NFC tag 36 may include an actuation member 42 for actuating a switch on the NFC tag or otherwise interacting with the NFC tag. In one embodiment, the actuation member 42 is configured to open/close the NFC circuit in response to engagement with the battery cover 40 of the article of merchandise M. In some embodiments, the actuation member 42 is a plunger or contact switch coupled to or integrated with the NFC tag 36. The NFC tag 36 may be secured to the article of merchandise M, such as on the battery 18, with a pressure-sensitive adhesive or the like. When the NFC tag 36 is secured to the article of merchandise M, securing the battery cover 40 to the article of merchandise actuates the plunger switch to thereby open the NFC circuit. Should the battery cover 40 be removed, the plunger switch is again actuated and the circuit closes, thereby allowing communication between the NFC tag 36 and the article of merchandise M, which may result in a security signal being generated by the article of merchandise M. It is understood that the actuation member 42 may be various configurations suitable for switching or actuating the NFC circuit, such as with a snap dome or micro-switch, which may not require shorting or opening the circuit. Furthermore, although the NFC tag 36 has been described as being secured within and to the article of merchandise M, such as to the battery 18, the NFC tag and any associated actuation member 42 may alternatively be secured directly to (or integrated with) a removable component of the article of merchandise, such as the battery cover 40. Thus, removal of the battery cover 40 would similarly actuate the actuation member 42 due to disengagement with the article of merchandise M and result in the generation of a security signal.

According to one embodiment, the article of merchandise M may include an NFC tag 36 or reader that is disposed within a battery cover 40 or other removable component (see, e.g., FIG. 5). Thus, the battery cover 40 or other removable component may include an NFC tag 36 with an antenna. The article of merchandise M may include one or more electrical contacts 44 that are configured to mate with and come into electrical communication with electrical contacts 45 of the NFC tag 36. Thus, when the battery cover 40 is secured to the article of merchandise M, electrical contact is made with the contacts 44, 45, and the article of merchandise can communicate with the NFC tag 36.

In one embodiment, a security NFC tag 36a is secured to the article of merchandise M (e.g., to the battery 18 with a pressure-sensitive adhesive) and includes one or more electrical contacts 45 that are configured to correspond to and come into electrical communication with one or contacts 44 of the article of merchandise and one or more contacts 45 of the NFC tag 36b associated with the cover. Thus, the security NFC tag 36a may be positioned between the article of merchandise M and the battery cover 40. Therefore, when the battery cover 40 is secured to the article of merchandise M, the electrical contacts 44, 45 of the article of merchandise, the security NFC tag 36a, and the NFC tag 36b on the battery cover are in electrical communication with one another, and the article of merchandise can communicate with the NFC tag associated with the battery cover. The security NFC tag 36a may define a circuit that is configured to allow the security NFC tag to communicate with the article of merchandise M when the battery cover 40 is removed, but to not communicate with the article of merchandise when the battery cover is secured to the article of merchandise. For instance, the security NFC tag 36a may include an actuation member 42 configured to open/close the circuit in response to engagement of the battery cover 40 of the article of merchandise M. Although different types of actuation members 42 may be employed, in one embodiment, the actuation member is a plunger or contact switch that is actuated when the battery cover 40 is secured to the article of merchandise M to thereby open or disconnect the NFC circuit. Should the battery cover 40 be removed, the plunger switch is again actuated and the circuit closes or connects, causing the security NFC tag 36a to communicate with the article of merchandise M, which may result in a security signal being generated by the article of merchandise. As such, the antenna of the security NFC tag 36a may communicate directly with the article of merchandise M.

Therefore, in some embodiments, the security device 30 may be a standalone solution without the use of a sensor. Thus, the NFC tag 36 coupled to the article of merchandise M may perform the necessary security functions. In this particular embodiment, the security device 30 may be entirely wireless (i.e., no tethers, recoiler cables, power cords, etc.). In one alternative, the security device 30 may include a power cord coupled to an input port on the article of merchandise M that provides additional security and/or power. Namely, the power cord may include a sense loop that detects when the power cord connector has been removed from the article of merchandise M and/or has been cut or otherwise tampered with.

In the instance where no cords are utilized, other techniques may be used to provide additional security. For example, the article of merchandise M may incorporate functionality for determining a distance that the article of merchandise has moved from an authorized “home position”, such as a location of a display stand or area. Should the article of merchandise M be moved beyond a predetermined allowable distance, a security signal may be generated. Thus, the security device 30 may utilize various positioning functionality of the article of merchandise, such as a Global Positioning System (GPS) satellite receiver, gyroscopes, and/or accelerometers, as are known in the art. In one embodiment, such functionality may be performed using techniques disclosed in U.S. Publication No. 2012/0293330, entitled Systems and Methods for Protecting Retail Display Merchandise From Theft, filed May 18, 2012, which is hereby incorporated by reference in its entirety. Should the user of the article of merchandise carry the article of merchandise M beyond an acceptable distance from the home position, a security signal may be generated, such as an audible, a visible, and/or a haptic signal warning the user to return the article of merchandise to, or near, the home position.

In another embodiment, the security device 30 further includes a security sensor 32 secured to the article of merchandise (see, e.g., FIGS. 2 and 3). For instance, the security sensor 32 may be secured with a pressure-sensitive adhesive or other securing technique that allows the sensor to be removable. The sensor 32 may be mounted on an outer surface of the battery cover 40 of the article of merchandise M and may include one or more NFC tags 36 (e.g., one NFC tag and one or more chips). The NFC tags 36 may be coupled to the sensor 32, such as being secured to the sensor or integrated therewith. In one embodiment, the sensor 32 includes a plurality of NFC tags 36 configured to communicate with the article of merchandise M, such as with the article of merchandise and/or an NFC tag associated with the article of merchandise. The NFC tags 36 may be selectively read in response to actuation of a switch 39. For example, the sensor 32 may include an NFC tag 36 for detecting removal of the sensor from the article of merchandise M, an NFC tag for detecting that a tether 34 or cable coupled to the sensor has been cut, and/or an NFC tag for detecting the presence of a key 50. In this regard, while power is being provided to an NFC tag 36, one NFC tag will be able to be read by or otherwise communicate with the article of merchandise M (switch 39 closed), while a second NFC tag will not (switch 39 open). When power is removed, the readable NFC tag 36 now becomes unreadable by the article of merchandise M, and the other NFC tag can now be read. A third NFC tag 36 may be enabled if a correct “handshake” has taken place with a key 50, such as via wireless communication. Thus, the article of merchandise M may be configured to communicate with each NFC tag 36 in response to certain security events. In one embodiment, the key 50 is an InVue Security Products Inc. infrared key that is configured to sense the presence or lack of, of one or more NFC tags 36. The combination of these NFC tags 36 will allow the article of merchandise M to sense if the sensor 32 is removed from the article of merchandise and/or if the tether 34 or recoiler cable is cut.

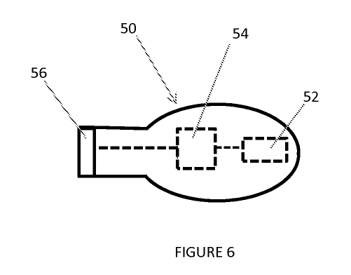

Thus, the key 50 itself may include NFC functionality or one or more NFC tags 52 for communicating with the security device 30 and/or the article of merchandise M (see, e.g., FIG. 6). For example, the key 50 may include at least one NFC tag 52 that is configured to recognize or otherwise communicate with an NFC tag 36 associated with the security device 30 and to arm or disarm the security device. The key 50 may also house various other components, such as a controller, a logic control circuit, or a printed circuit board 54, a battery, and/or an EAS tag. The key 50 may include an actuation member for actuating the key. The actuation member may be in communication with the NFC tag(s) 52, a logic control circuit, controller, or PCB 54 of the key and may be configured to be actuated in response to a signal from the logic control circuit, controller, or PCB.

In the alternative to an NFC tag 52, it is understood that the key 50 may include circuitry or otherwise be configured to communicate with one or more NFC tags 36 associated with the security device 30 and/or the article of merchandise M. For example, the key 50 may include an inductive coil 56 that is configured to transmit electrical power that is operable to communicate with the NFC coil 24 in the security device (see, e.g., FIG. 3). Thus, the coils 24, 56 may be configured to communicate with one another to arm or disarm the security device. Further discussion regarding data and electrical communication between an electronic key and a security device may be found, for example, in U.S. Publication No. 2012/0047972, which is hereby incorporated by reference in its entirety.

Furthermore, the key 50 may include a time-out function. More particularly, the ability of the key 50 to arm or disarm the security device 30 may be deactivated after a predetermined time period. By way of example, the key 50 may include a logic control circuit 54 that is configured to be deactivated after about six to twelve hours (e.g., about eight hours) from the time the key was programmed or last refreshed (e.g., by a remote programming station). In this manner, an authorized sales associate typically must program or refresh the key 50 assigned to him or her at the beginning of each work shift. Thus, the key 50 would have to be programmed or refreshed with a security device code in order to reactivate the logic control circuit of the key. In one example, the key 50 may include a pair of NFC tags 52, wherein the logic control circuit 54 is configured to switch between the first and second NFC tags relative to a predetermined period of time. The first NFC tag 52 indicates that the key has not timed out and is able to arm or disarm the security device 30. The second NFC tag 52 indicates that the key 50 has timed out and does not allow the key to arm or disarm the security device 30. The second NFC tag 52 could also be configured to communicate with the security device 30 and/or the article of merchandise M to indicate that the key needs to be reprogrammed or refreshed with a new security code.

In some embodiments of the present invention, the security device 30 provides for wireless or contact charging. In one embodiment, an inductive transmitter or coil (e.g., a Qi transmitter) is configured to wirelessly communicate with an inductive receiver or receiver coil (e.g. Qi receiver). For instance, the transmitter and receiver may be any suitable Qi compliant transmitter that satisfy the “Qi standard” or “Qi specification”. The inductive transmitter and receiver may be located in various locations for wireless communication. For example, the transmitter may be operably engaged with a base or display surface, while the receiver is operably engaged with the article of merchandise M. In another embodiment, the transmitter may function directly with a receiver in the article of merchandise M. Thus, wireless charging may occur using the existing hardware of the article of merchandise M. In addition, the article of merchandise M may be wirelessly charged even with the sensor 32 present thereon. Thus, the presence of the sensor 32 and one or more NFC tags 36 between the source of power and the article of merchandise M may not inhibit wireless charging of the article.

Moreover, the security device 30 may include a tether 34 or recoiler cable coupled to the sensor 32. The tether 34 may be attached to a base and to the sensor 32 and may include one or more conductive elements for transmitting power and/or security signals to the NFC tags 36, sensor 32, and/or the article of merchandise M. For example, the tether 34 may be used to provide power only to the NFC tags 36 associated with the sensor 32. In other embodiments, the tether 34 may simply be a mechanical cable with no power or signal transmission capability. In addition, the tether 34 may incorporate a cut-resistance cable or sheath. Likewise, a recoiler cable 24 may include similar characteristics and functionality that may be used to transmit power and/or security signals to the NFC tags 36, the sensor 32, and/or the article of merchandise M. In one aspect, a battery 52 is incorporated with a recoiler 54 and carried thereby so as to be configured to rotate with the recoiler (see, e.g., FIG. 3). Where the security device 30 includes one or more NFC tags 36 operably engaged with a sensor 32, the NFC tags may be controlled electronically by the power transmitted by the battery 52 or some other power source transmitted through the tether 24 or recoiler cable to the NFC tags.

The foregoing has described one or more embodiments of devices for securing articles of merchandise. Those of ordinary skill in the art will understand and appreciate that numerous variations and modifications of the invention may be made without departing from the spirit and scope of the invention. Accordingly, all such variations and modifications are intended to be encompassed by the appended claims.

1. A security device for securing an article of merchandise comprising:
at least one near field communication (NFC) tag coupled to the article of merchandise, wherein the at least one NFC tag is configured to detect at least one security event in response to tampering with the article of merchandise.

2. The security device of claim 1, wherein the at least one NFC tag is contained within the article of merchandise.

3. The security device of claim 2, wherein the at least one NFC tag is configured to be in engagement with a battery cover of the article of merchandise when the battery cover is secured to the article of merchandise.

4. The security device of claim 3, further comprising an actuation member configured to interact with the at least one NFC tag when the battery cover is secured to or removed from the article of merchandise.

5. The security device of claim 4, wherein the at least one NFC tag is configured to detect removal of the battery cover of the article of merchandise in response to actuation of the actuation member.

6. The security device of claim 3, wherein the actuation member comprises a shorting member secured to the battery cover of the article of merchandise and opposite the at least one NFC tag so as to be configured to short the at least one NFC tag when the battery cover is secured to the article of merchandise.

7. The security device of claim 3, wherein the actuation member is coupled to the at least one NFC tag and is configured to be actuated in response to engagement and disengagement with the battery cover of the article of merchandise.

8. The security device of claim 3, wherein the security event is indicative of the battery cover being removed from the article of merchandise.

9. The security device of claim 1, wherein the at least one NFC tag is configured to communicate with the article of merchandise to generate a security signal in response to detecting a security event.

10. The security device of claim 1, further comprising a sensor comprising at least one NFC tag configured to be coupled to the article of merchandise, wherein the at least one NFC tag of the sensor is configured to detect at least one security event in response to tampering of the sensor.

11. (canceled)

12. (canceled)

13. (canceled)

14. (canceled)

15. A method for securing an article of merchandise comprising:
detecting at least one security event with at least one near field communication (NFC) tag associated with the article of merchandise in response to tampering with the article of merchandise; and
generating a security signal in response to detecting the at least one security event.

16. The method of claim 15, wherein the at least one NFC tag is positioned within the article of merchandise.

17. The method of claim 15, wherein the at least one NFC tag is coupled to the article of merchandise

18. The method of claim 17, wherein the at least one NFC tag is coupled to the article of merchandise such that the at least one NFC tag is configured to be in engagement with a battery cover of the article of merchandise when the battery cover is secured to the article of merchandise.

19. The method of claim 15, wherein detecting comprises detecting that a battery cover of the article of merchandise has been removed.

20. The method of claim 15, wherein the at least one NFC tag is contained within a sensor configured to be coupled to the article of merchandise.

21. A security system for securing an article of merchandise comprising:
a security device comprising at least one near field communication (NFC) tag coupled to the article of merchandise, wherein the NFC tag is configured to detect at least one security event in response to tampering with the article of merchandise; and
a key comprising at least one NFC tag configured to communicate with the at least one NFC tag of the security device to arm or disarm the security device.

22. The security system of claim 21, wherein the key comprises a pair of NFC tags, and wherein a first of the pair of NFC tags is configured to communicate with the security device for a predetermined period of time, and a second of the pair of NFC tags is configured to communicate with the security device after the predetermined period of time.
